(19) United States
(12) Patent Application Publication
(10) Pub. No.: US 2009/0263298 A1
(43) Pub. Date: Oct. 22, 2009

(54) PHOTOCATALYST DEVICE

(75) Inventors: Chih-Peng HSU, HuKou (TW); Chung-Min CHANG, HuKou (TW); Tse-An LEE, HuKou (TW)

Correspondence Address: PCE INDUSTRY, INC.;ATT. Steven Reiss, 288 SOUTH MAYO AVENUE, CITY OF INDUSTRY, CA, 91789, US

(73) Assignee: ADVANCED OPTOELECTRONIC TECHNOLOGY, INC., Hsinchu Hsien (TW)

(21) Appl. No.: 12/332,320

(22) Filed: Dec. 10, 2008

(30) Foreign Application Priority Data
Apr. 18, 2008 (CN) 200810301213.2

(51) Int. Cl. B01J 21/06; G01J 3/10

(52) U.S. Cl. 422/186.3; 250/504 R

(57) ABSTRACT

A photocatalyst device includes a photocatalyst member and a light source. The light source is configured to emit ultraviolet light to the photocatalyst member. The ultraviolet light has a wavelength equal to or less than about 400 nanometers, and more than 365 nanometers.

### BACKGROUND

1. Technical Field

The disclosed embodiments relates to a photocatalyst device.

2. Description of Related Art

When photocatalyst materials, for example, titanium dioxide (TiO₂), are irradiated with light sources having energy higher than the band gap thereof, electrons are produced in the conduction band and holes are produced in the valence band due to photo-excitation. The strong reducing power of the electrons and the strong oxidizing power of the holes are utilized for photocatalytic reactions, such as decomposing and purifying noxious materials, deodorizing malodorous gases, and killing bacteria.

A typical photocatalyst device applies solar light or a mercury lamp as the light source. However, those light sources cannot emit suitable wavelengths to photocatalyst materials. Thus, photocatalytic efficiency is low.

Therefore, a new photocatalyst device is desired to overcome the above-described shortcoming.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of one embodiment of a photocatalyst device.

FIG. 2 is a graph showing a relation between nitrogen oxide gas concentration and time.

FIG. 3 is a graph showing a relation between the light absorption rate of a photocatalyst member and the wavelength of ultraviolet light, a relation between the output power of light emitting diodes and the wavelength of the ultraviolet light, a relation between the power of absorbed ultraviolet light and the wavelength of the ultraviolet light, and a relation between the decomposition rate of the nitrogen oxide gas and the wavelength of the ultraviolet light.

### DETAILED DESCRIPTION OF THE EMBODIMENTS

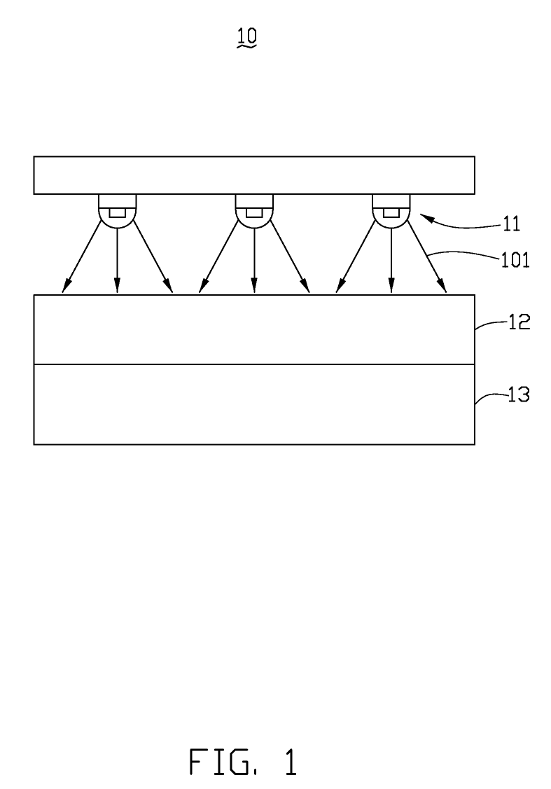

Referring to FIG. 1, one embodiment of a photocatalyst device 10 includes a light source 11, a photocatalyst member 12, and a substrate 13. The light source 11 is configured to emit ultraviolet lights 101 to the photocatalyst member 12. The photocatalyst member 12 is positioned on the substrate 13 and contains TiO₂ photo catalyst.

The light source 11 includes a plurality of light emitting diodes (LEDs). Each LED 11 may be a gallium nitride (GaN) LED or an aluminum indium gallium nitride (AlInGaN) LED, and is configured to emit ultraviolet light 101 having a wavelength of about 365 nanometers to about 400 nanometers. In one embodiment, each LED 11 is configured to emit the ultraviolet light 101 having the wavelength of about 375 nanometers to about 395 nanometers.

In one embodiment, the LEDs 11 may be electrically connected in parallel to a constant current source so that the ultraviolet lights 101 may have substantially stable wavelengths. In another embodiment, each LED 11 may be electrically connected in series to a ballast resistor. In yet another embodiment, the LEDs 11 may be electrically connected in series to a constant current source. In still another embodiment, each LED 11 may be electrically connected to a constant current source. In another embodiment, the LEDs 11 may be electrically connected in parallel to a constant voltage source. Each LED 11 may be electrically connected in series to a ballast resistor.

The photocatalyst member 12 may be a layer of TiO₂ nanoparticles, a thin film containing TiO₂ photocatalyst, or a filtering membrane containing TiO₂ photocatalyst. TiO₂ has three forms: anatase, rutile, and brookite. The anatase TiO₂ has the highest photocatalytic activity. In one embodiment, TiO₂ may be in anatase form. In another embodiment, TiO₂ may be a mixture of the anatase form and the rutile form, or a mixture of the anatase form and the brookite form. The photocatalyst member 12 may be doped with dopant materials for increasing photocatalystic activity, such as silver.

The substrate 13 may be made of a material selected from the group comprising of aluminum, foamed nickel, and porous ceramic.

For exemplary purposes only, experiments of decomposing nitrogen oxide (NO_{X}) gas using the photocatalyst device 10 of FIG. 1 is described below. In the experiments, five AlInGaN LEDs 11 are provided, TiO₂ is in anatase form, and the NO_{X} gas has a concentration of 1 ppm, a flow of 1 L/min, a temperature of 23 centigrade, and a humidity of 55%.

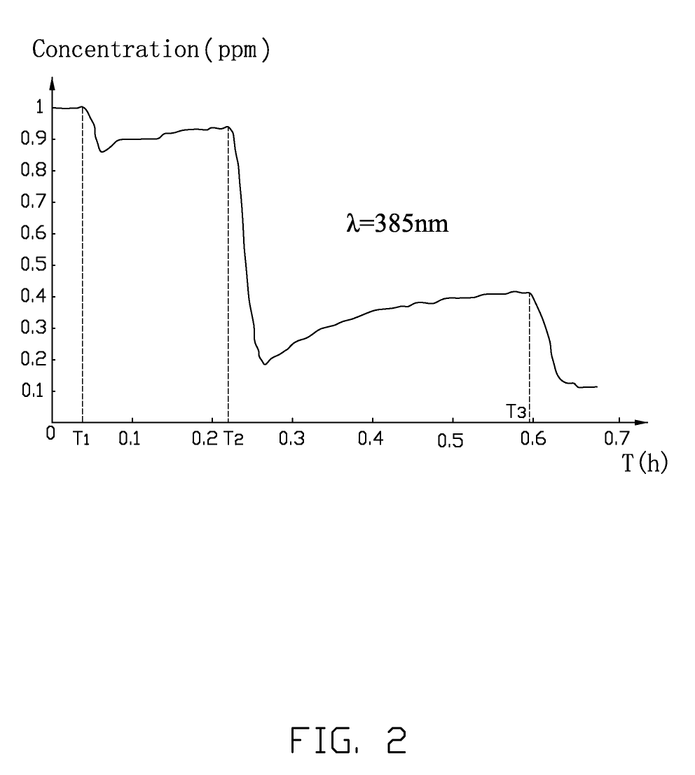

In Experiment 1, referring to FIG. 2, a longitudinal axis represents the concentration of the NO_{X} gas, and a lateral axis represents time. At time T1, the NO_{X} gas is supplied to contact the photocatalyst member 12. At time T2, a first AlInGaN LED 11 is turned on to emit ultraviolet light 101 having a wavelength of about 385 nanometers. At time T3, the supplied NO_{X} gas is stopped, and the first AlInGaN LED 11 is turned off. From time T2 to time T3, the concentration of the NO_{X} gas has largely decreased. After time T3, a small amount of NO_{X} gas remains. The decomposition rate of the NO_{X} gas is about 70%.

Experiment 2 is similar to Experiment 1, except that a second AlInGaN LED 11 emits ultraviolet light 101 having a wavelength of about 365 nm. The decomposition rate of the NO_{X} gas is about 40%.

Experiment 3 is similar to Experiment 1, except that a third AlInGaN LED 11 emits ultraviolet light 101 having a wavelength of about 375 nm. The decomposition rate of the NO_{X} gas is about 62%.

Experiment 4 is similar to Experiment 1, except that a fourth AlInGaN LED 11 emits ultraviolet light 101 having a wavelength of about 395 nm. The decomposition rate of the NO_{X} gas is about 62%.

Experiment 5 is similar to Experiment 1, except that a fifth AlInGaN LED 11 emits ultraviolet light 101 having a wavelength of about 400 nanometers. The decomposition rate of the NO_{X} gas is about 53%.

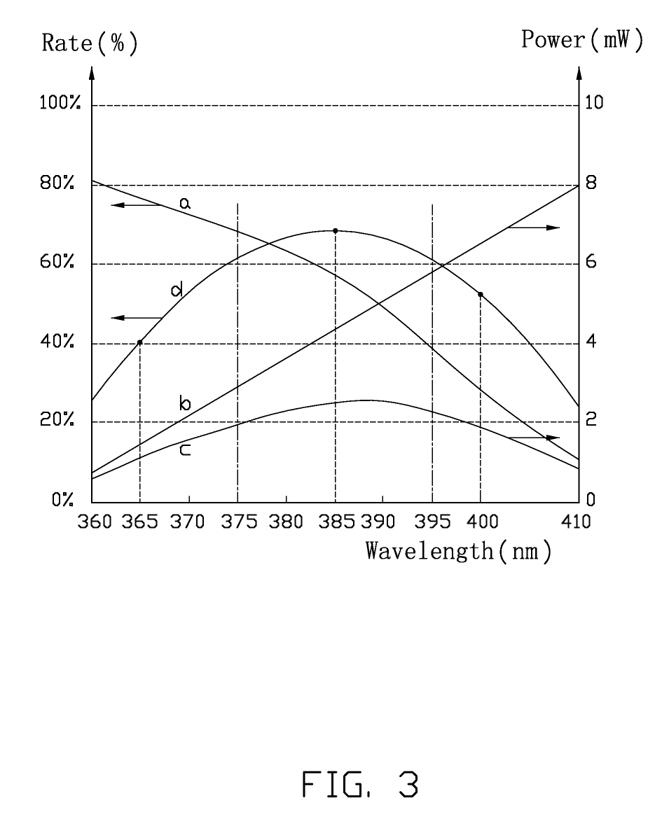

Referring to FIG. 3, one longitudinal axis represents light absorption rate of the photocatalyst member 12, or the decomposition rate of the NO_{X} gas. Another longitudinal axis represents output power of the LED 11. A lateral axis represents the wavelength of ultraviolet light 101 emitted from the LED 11. A curve “a” shows a relation between the light absorption rate and the wavelength. A curve “b” shows a relation between the output power and the wavelength. A curve “c” shows a relation between the power of absorbed ultraviolet light and the wavelength. A curve “d” shows a relation between the decomposition rate and the wavelength, and is obtained according to the above-mentioned experimental results. As shown in the curve “d”, the photocatalyst member 12 that absorbed the ultraviolet lights 101 having the wavelengths from about 375 nanometers to about 395 nanometers, decomposes the NO_{X} gas from about 62% to about 70%.

The energy of the light depends on the light wavelength, because the shorter the light wavelength, the larger the energy of light. Therefore, the light source for photocatalyst device should emit light having a short wavelength of at least less than 365 nm. However, the photocatalyst member 12 of FIG. 1 that absorbed ultraviolet lights having wavelengths from about 375 nanometers to about 395 nanometers had a higher decomposition efficiency.

It is believed that the present embodiments and their advantages will be understood from the foregoing description, and it will be apparent that various changes may be made thereto without departing from the spirit and scope of the embodiments or sacrificing all of its material advantages, the examples here before described merely being preferred or exemplary embodiments.

What is claimed is:

1. A photocatalyst device, comprising a photocatalyst member and a light source configured to emit ultraviolet light to transmit to the photocatalyst member, wherein the ultraviolet light has a wavelength equal to or less than 400 nanometers, and more than 365 nanometers.

2. The photocatalyst device of claim 1, wherein the ultraviolet light has a wavelength of about 375 nanometers to about 395 nanometers.

3. The photocatalyst device of claim 2, wherein the ultraviolet light has a wavelength of about 385 nanometers.

4. The photocatalyst device of claim 1, wherein the light source comprises a plurality of light emitting diodes.

5. The photocatalyst device of claim 4, wherein the plurality of light emitting diodes is gallium nitride light emitting diodes.

6. The photocatalyst device of claim 1, wherein the photocatalyst member comprises a titanium dioxide photocatalyst.

7. The photocatalyst device of claim 6, wherein the photocatalyst member is a layer of titanium dioxide nanoparticles.

8. The photocatalyst device of claim 6, wherein the photocatalyst member is a thin film comprising a titanium dioxide photocatalyst.

9. The photocatalyst device of claim 6, wherein the photocatalyst member is a filtering membrane comprising a titanium dioxide photocatalyst.

10. The photocatalyst device of claim 1, wherein the photocatalyst member is doped with silver.

11. The photocatalyst device of claim 1, further comprising a substrate, wherein the photocatalyst member is positioned on the substrate.

12. A light source for a photocatalyst device, comprising a plurality of light emitting diodes configured to emit ultraviolet light having a wavelength of about 375 nanometers to about 395 nanometers.

13. The light source of claim 12, wherein the ultraviolet light has wavelength of about 385 nanometers.

14. The light source of claim 12, wherein the plurality of light emitting diodes is a plurality of gallium nitride light emitting diodes.

15. The light source of claim 12, wherein the plurality of light emitting diodes is a plurality of aluminum indium gallium nitride light emitting diodes.

16. The light source of claim 12, wherein the plurality of light emitting diodes is electrically connected in parallel to a constant current source; each light emitting diode is electrically connected in series to a ballast resistor.

17. The light source of claim 12, wherein the plurality of light emitting diodes is electrically connected in series to a constant current source.

18. The light source of claim 12, wherein each light emitting diode is electrically connected to a constant current source.

19. The light source of claim 12, wherein the plurality of light emitting diodes is electrically connected in parallel to a constant voltage source; each light emitting diode is electrically connected in series to a ballast resistor.

20. A photocatalyst device, comprising:
a photocatalyst member comprising a titanium dioxide photocatalyst; and
a light source configured to emit ultraviolet light to the photocatalyst member, wherein the ultraviolet light has a wavelength of about 375 nanometers to about 395 nanometers.
